(19) United States
(12) Patent Application Publication
(10) Pub. No.: US 2007/0155840 A1
(43) Pub. Date: Jul. 5, 2007

(54) USE OF QUATERNARY AMMONIUM COMPOUNDS IN THE PREVENTION OF MOLD, MILDEW, AND FUNGUSES IN NEW AND/OR EXISTING CONSTRUCTION

(75) Inventors: Joe D. Sauer, Baton Rouge, LA (US); George W. Cook JR., Baton Rouge, LA (US); Christopher S. Knight, Prairieville, LA (US)

Correspondence Address: EDGAR SPIELMAN;ALBEMARLE CORPORATION, 451 FLORIDA BLVD., BATON ROUGE, LA, 70801, US

(73) Assignee: Albemarle Corporation, Baton Rouge, LA (US)

(21) Appl. No.: 11/613,298

(22) Filed: Dec. 20, 2006

Related U.S. Application Data
(60) Provisional application No. 60/864,276, filed on Nov. 3, 2006.
(60) Provisional application No. 60/864,272, filed on Nov. 3, 2006.
(60) Provisional application No. 60/773,241, filed on Feb. 13, 2006.
(60) Provisional application No. 60/752,275, filed on Dec. 20, 2005.
(60) Provisional application No. 60/752,349, filed on Dec. 20, 2005.

(51) Int. Cl. A01N 33/12

(52) U.S. Cl. 514/642; 514/643

(57) ABSTRACT

The present invention relates to the use of quaternary ammonium compounds in the prevention of microbial growth such as mold, fungus, and mildew in new and/or existing construction.

### CROSS-REFERENCE TO RELATED APPLICATIONS

The present application claims priority to U.S. Provisional Application No. 60/752,349 and U.S. Provisional Application No. 60/752,275, both filed Dec. 20, 2005; U.S. Provisional Application No. 60/773,241, filed Feb. 13, 2006; U.S. Provisional Application No. 60/864,272, filed Nov. 3, 2006; and U.S. Provisional Application No. 60/864,276, filed Nov. 3, 2006; all of which are hereby incorporated by reference in their entirety.

### FIELD OF THE INVENTION

The present invention relates to the use of quaternary ammonium compositions in the prevention of unwanted microbial growth such a mold, fungus, and mildew in new and/or existing construction.

### BACKGROUND OF THE INVENTION

It has been presented and discussed on numerous occasions that certain molds, mildews, and/or funguses pose a health hazard to many individuals, and the issue of remediation of such organisms is a constant problem in the construction industry. For example, certain buildings and locations within buildings lend themselves to more readily promote or facilitate the growth of funguses, molds, and/or mildews, e.g., basements, crawl spaces, etc. Further, depending upon the particular type of building, and the particular geographic area in which the building is found, these buildings may provide suitable environments for microbial growth. For instance, spaces that are not adequately ventilated and/or exposed to moisture can contribute to growth of microbes, and in some instances in new construction, some spaces are often not ventilated until final steps in the construction, allowing mold to grow and colonize at unacceptable levels, and the mold may quickly spread to other areas within the building. Further, with the recent hurricanes in South Louisiana, the issue of mold, fungus, and mildew remediation became of more interest to those whose homes, buildings, etc, were flooded. The solution for most of these instances has been to use remediation techniques to control or eliminate the microbes.

However, it would be beneficial to prevent the growth of these microbial organisms, and thus eliminate or minimize the need for remediation. Generally, the prevention of the growth of microbes has been achieved by using building material pre-treated with anti-microbial products. While this technique is effective, it is typically not a solution that will last for the life of the building or structure, and is typically more expensive because of the treatment of the building material. For example, the use of pressure treated or other treated lumber in the construction of a new house is cost prohibitive. Further, many treatments involve the use of heavy metals such as copper, arsenic, etc., which can pose health concerns for those coming in contact with them.

Therefore, it would be beneficial to the construction industry and home/building owners to have a prophylactic means for treating new and or existing construction to prevent and/or inhibit the growth of unwanted microbial organisms.

### SUMMARY OF THE INVENTION

Quaternary ammonium compounds or “quats” for short find use in many industrial applications. Quats are loosely defined as a group of compounds generally having the formula R₁R₂R₃R₄—N⁺Y⁻, where the radicals may be the same, different, or part of a ring and Y is a counter anion. Typically, but not always, one of the radicals is a long-chain alkyl group. In most industrial applications, these quat molecules are complexed with a counter ion (anion) to provide for an “active” molecule.

The inventors hereof have discovered that the use or application of at least one quaternary ammonium compound, sometimes only one, sometimes more than one wherein the more than one contemplates quaternary ammonium compounds having the same or different counter anions, or a prophylactic solution comprising at least one quaternary ammonium compound, sometimes only one sometimes more than one wherein the more than one contemplates quaternary ammonium compounds having the same or different counter anions, can provide for an effective, non-oxidizing prophylactic measure for microbial organisms. In some embodiments, the application of the at least one quaternary ammonium compound or the prophylactic solution can also impart to the one or more articles some flame retardant properties. In some embodiments, when the quaternary ammonium compound in the prophylactic solution or otherwise has as it counter anion borate, as described below, the application of the at least one quaternary ammonium compound or the prophylactic solution can also impart to the one or more articles some termite repellant properties. In this embodiment, the one or more articles to which the at least one quaternary ammonium compound or the prophylactic solution is applied must obviously be susceptible to termite damage, i.e., cellulosic substrates such as wood, cotton, paper, or bagasse-based building products. Non-limiting examples of these products include ceiling tiles, wooden furniture, wallboards, etc., and the like. By repelling termites, it is meant that the termites do not feed on the quat treated cellulosic material, and in essence may resort to cannibalistic behavior for food or search for a different food source, if one is available, instead of feeding on the quat treated cellulosic material as a food source.

Thus, in one embodiment, the present invention relates to a method for the prevention and/or inhibition of microbial organism growth. The method comprises applying to one or more article a quaternary ammonium compound having the formula:

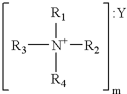

wherein Y is selected from H₂BO₃⁻; HBO₃⁻²; BO₃⁻³; B₄O₇⁻; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y; and

wherein said one or more articles are present in an environment that can facilitate or encourage the growth of at least one microbial.

In some embodiments a prophylactic solution comprising at least one quaternary ammonium compound is applied to the one or more article.

### DETAILED DESCRIPTION OF THE INVENTION

“Microbial”, “microbe” and “microbial organism” can be used interchangeably herein and are used herein in the broadest sense and are meant to include one or more of the following: molds, mildews, funguses, and the like. In some embodiments, the microbial is considered a contaminant to the one or more article(s).

Thus, by present in an environment that can facilitate or encourage the growth of at least one microbial, it is meant an environment that facilitates or encourages the growth of one or more molds, mildews, funguses, and the like. In some embodiments, these environments are generally moist or humid environments wherein the relative humidity can reach 60% or greater and/or wherein poor ventilation is available, which contributes to moist of humid conditions. In some embodiments, the environment is also warm, for example, 55° F. (average temperature) or higher.

Also, “building” as used herein is also used in its broadest sense and is meant to include homes, office and/or other commercial buildings, storage units or buildings, apartments, mobile homes, travel trailers, detached garages, camps, and the like.

“Construction material” as used herein is also used in its broadest sense and is meant to encompass any material used in the construction of homes and buildings upon which microbial organisms can grow. Thus, “construction material” as used herein is meant to encompass wood, cotton, cardboard, liner board, other similar paper products, composite assemblies, and the like.

Articles

In some embodiments, the one or more articles to which the quaternary ammonium compound or the prophylactic solution is applied is a construction material. In some embodiments, the article can be any one of the following: i) gypsum board; ii) ceiling tiles or other ceiling material made form natural or synthetic materials; iii) particleboard or other similar composite material used in the construction of a building, i.e. fiber board, press-board, and the like; iv) synthetic wood, i.e. synthetic doors molded from resin materials, synthetic moldings, etc; v) carpeting; vii) padding used under carpeting; viii) insulation, be it made from natural or synthetic materials; ix) wood; x) concrete or other similar porous material; xi) porous tiles such as flooring or wall tiles; xii) synthetic materials used in the construction of buildings, i.e. artificial marbles, stones, resins such as fiberglass, etc; xiii) bricks; and ix) any combinations thereof.

In some embodiments, the article is selected from one or more of the following: curtains, bed sheets, furniture (sofas, chairs, tables, beds, and the like), and the like.

Quaternary Ammonium Compound

The term “quaternary ammonium compound” and “quat”, as used herein, refers to a compound having the general formula R₁R₂R₃R₄—N⁺Y⁻, where the radicals may be the same, different, or part of a ring and Y is a counter anion. The organic radicals can be alkyl or alkenyl (unsaturated alkyls) groups that are linear or branched, substituted or unsubstituted, or mixtures thereof. The term “quaternary ammonium compound” or “quat” is also intended to encompass a compound in which one of the four organic radicals of a quat may be a “shared” radical with a second quat.

The quaternary ammonium compounds used in the present invention have the general formula:

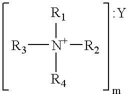

wherein Y is a counter-anion and m can be 1, 2, 3, 4, or 5, depending on the selection of Y.

The counter-anion of the quaternary ammonium compounds, Y, used in the present invention can be selected from borate anions, phosphate anions, carbonate anions (CO₃⁻²), bicarbonate anions (HCO₃⁻), and carboxylate anions ([CO₂⁻]ₙR₅). Thus, in some embodiments, Y is a borate anion, or a phosphate anion, or a bicarbonate anion, or a carbonate anion or a carboxylate anion. In the case where two quaternary ammonium compounds are present, it is preferred that the counter anion of one of the quats is a bicarbonate anion and/or a carbonate anion, or a phosphate anion or a carboxylate anion, and the counter anion of the other quaternary ammonium compound is a borate anion.

Borate anions suitable for use herein include the dihydrogen borate anion, H₂BO₃⁻; the hydrogen borate anion, HBO₃⁻²; the borate anion, BO₃⁻³; the tetraborate anion, B₄O₇⁻²; the hydrogen tetraborate anion, HB₄O₇⁻; B₃O₅⁻; pentaborate, B₅O₈⁻²; and BO₂⁻. Thus, Y is suitable selected from H₂BO₃⁻; HBO₃⁻²; BO₃⁻³; B₄O₇⁻²; HBO₄O₇⁻; B₃O₅⁻; B₅O₈⁻²; and BO₂⁻. If Y is a borate anion, it is preferred that Y is BO₃⁻³, and m is 3.

Phosphate anions suitable for use herein include the phosphate anion, PO₄⁻³; the hydrogen phosphate anion, HPO₄⁻²; the dihydrogen phosphate anion, H₂PO₄⁻; the diphosphate anion, P₂O₇⁻⁴, and the triphosphate anion, P₃O₁₀⁻⁵. Thus, Y is suitably selected from PO₄⁻³, HPO₄⁻², H₂PO₄⁻, P₂O₇⁻⁴, P₃O₁₀⁻⁵, and PO₃⁻. If Y is a phosphate anion, it is preferred that Y is PO₄⁻³, and m is 3.

Carboxylate anions suitable for use herein have the general formula [CO₂⁻]ₙR₅, wherein n is an integer equal to or greater than 1 and R₅ is chosen from substituted, unsubstituted, saturated, or unsaturated alkyl groups containing in the range of from 1 to 25 carbon atoms. In some preferred embodiments, R₅ contains in the range of from about 10 to about 20 carbon atoms, in some embodiments in the range of from 10 to 12 carbon atoms, in other embodiments in the range of from 12 to 14 carbon atoms, in other embodiments in the range of from 12 to 14 carbon atoms, in other embodiments in the range of from 14 to 16 carbon atoms, and in still other embodiments in the range of from 16 to 18 carbon atoms.

In some embodiments, the quats used in the present invention are metal coupler free. By metal coupler free, it is meant that the quats do not contain metals such as copper, mercury, lead, cadmium, hexavalent chromium, arsenic, antimony, or zinc. These metals are commonly used for their biocidal properties. However, these and other “heavy” metals pose certain environmental concerns, thus, it would be beneficial to remediate articles without the use of these heavy metals.

The four carbon chains, i.e. R₁, R₂, R₃ and R₄, of the quats used in the present invention are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. Alkyl and alkenyl groups suitable for use in the quats are those that contain in the range of from 1 to 20 carbon atoms. In preferred embodiments, R₁ and R₂ are independently chosen from alkyl groups having in the range of from 1 to 3 carbon atoms, and R₃ and R₄ are independently chosen in the range of from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3. In a more preferred embodiment, R₁ and R₂ are methyl groups and R₃ and R₄ are independently selected from unsubstituted alkyl groups containing in the range of from 8 to 14 carbon atoms. In one embodiment, one of R₃ or R₄ is an unsubstituted alkyl group containing in the range of from 8 to 10 carbon atoms, and one of R₃ or R₄ is an unsubstituted alkyl group containing in the range of from 12 to 14 carbon atoms.

In other embodiments of the present invention, at least one, sometimes only one and in other embodiments only two, or the four carbon chains, i.e. R₁, R₂, R₃ and R₄, is selected from i) substituted or unsubstituted alkyl groups that contain from 13 to 16, sometimes 14 to 16, sometimes 14, carbon atoms or ii) substituted or unsubstituted alkenyl groups that contain from 13 to 16, sometimes 14 to 16, sometimes 14, carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups. These carbon chains can be saturated or unsaturated, preferably unsubstituted. In these embodiments, it is particularly preferred to select unsaturated substituted or unsubstituted, preferably unsubstituted, alkyl groups containing from 13 to 16, sometimes 14 to 16, sometimes 14, carbon atoms. In these embodiments, at least two, in some embodiments only two, and in other embodiments three, of R₁, R₂, R₃ and R₄ are independently chosen from alkyl groups having from 1 to 4, sometimes 1 to 3, in some embodiments 2 to 4, carbon atoms. In these embodiments, it is also contemplated that one of R₁, R₂ , R₃ and R₄ be selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. The alkyl and alkenyl groups are those that contain from 1 to 20 carbon atoms. In preferred embodiments, the one of R₁, R₂, R₃ and R₄ is chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, sometimes 1, 2, or 3. In some embodiments, it is selected from unsubstituted alkyl groups containing from 8 to 14 carbon atoms. In other embodiments, it is selected from unsubstituted alkyl group containing from 8 to 10 carbon atoms, and in other embodiments, it is selected from unsubstituted alkyl groups containing from 12 to 14 carbon atoms.

In some embodiments of the present invention, it is preferred that at least two of the four carbon chains be independently selected chosen from alkyl groups having from 1 to 4, sometimes 1 to 3, in some embodiments 2to 4, carbon atoms, and two of the four carbon chains be independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, sometimes 1, 2, or 3, wherein ranges as described above are contemplated and the two of the four carbon chains independently chosen from 6 to 20 carbon atom-containing groups contain different numbers of carbon atoms. In still other embodiments, all of R₁, R₂, R₃ and R₄ are independently chosen from alkyl groups having in the range of from 1 to 3 carbon atoms, sometimes methyl groups.

In another embodiment, m is 2, and one of the four organic radicals of a quat may be a “shared” radical with a second quat. It should be noted that wile in this embodiment R₄ is shown as the shared radical, the shared radical can be any of R₁, R₂, R₃ or R₄. In this embodiment, the quaternary ammonium compounds used in the practice of the present invention have the general formula:

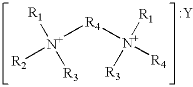

In this embodiment, R₁, R₂, R₃, R₄, are as described above including preferred embodiments, and Y is selected from those anions described above having an ionic charge of −2, in some embodiment a borate anion having an ionic charge of −2, in some embodiments, HBO₃⁻².

In another embodiment when m is 2, and one of the four organic radicals of a quat may be a “shared” radical with a second quat, the quaternary ammonium compounds used in the present invention have the general formula:

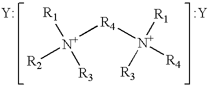

In this embodiment, R₁, R₂, R₃, R₄ are as described above including preferred embodiments, and each Y is independently selected from those anions described above having an ionic charge of −1, in some embodiments from borate anions having an ionic charge of −1, in other embodiments each Y is H₂BO₃⁻. It should be noted that while in this embodiment R₄ is shown as the shared radical, the shared radical can be any of R₁, R₂, R₃, or R₄.

In another embodiment m is 3, and one of the four organic radicals of a quat is a “shared” radical with a second quat. In this embodiment, the quaternary ammonium compounds used in the coating formulations of the present invention can have the general formula:

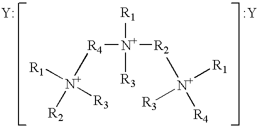

In this embodiment, R₁, R₂, R₃, and R₄ are as described herein including preferred embodiments, and one Y is independently selected from the counter-anions described above having an ionic charge of −2 and the other Y is selected from those counter-anions having an ionic charge of −1. In some embodiments, one Y is selected from H₂BO₃⁻; HB₄O₇⁻; B₃O₅⁻; and BO₂⁻ and the other Y is selected from HBO₃⁻²; B₄O₇⁻²; and B₅O₈⁻². It should be noted that while in this embodiment R₄ is shown as the shared radical, the shared radical can be any of R₁, R₂, R₃, or R₄.

In another embodiment when m is 3, and one of the four organic radicals of a quat may be a “shared” radical with a second quat, the quaternary ammonium compounds used in the present invention have the general formula:

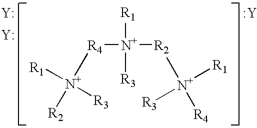

In this embodiment, R₁, R₂, R₃, and R₄ are as described above including preferred embodiments, and each Y is independently selected from those anions having a net ionic charge of −1. In some embodiments, each Y is independently selected from H₂BO₃⁻; HB₄O₇⁻; B₃O₅⁻. It should be noted that while in this embodiment R₄ is shown as the shared radical, the shared radical can be any of R₁, R₂, R₃, or R₄.

In some embodiments, m is 3 and Y is BO₃⁻³. In these embodiments, the quaternary ammonium compound used in the present invention have the general formula:

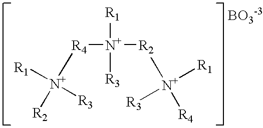

In this embodiment, R₁, R₂, R₃, or R₄ are as described above including preferred embodiments. It should be noted that while in this embodiment R₄ and R₂ are shown as the shared radicals, the shared radicals can be independently any of R₁, R₂, R₃, or R₄ or any combinations thereof. For example, R₄ and R₁ can be the shard radicals, R₁ and R₃ can be the shared radicals, etc. Also, all three nitrogen atoms can share the same radical group, independently selected from R₁, R₂, R₃, or R₄.

The quats of the present invention can be prepared by any methods known in the art, exemplary methods include those described in commonly-owned co-pending applications PCT US2005/010162 and U.S. Ser. No. 60/730,821, which are incorporated herein by reference in their entirety.

Prophylactic Solutions Containing the Quaternary Ammonium Compound

While the quat(s) can be applied to the one or more articles directly, it is preferred to apply a prophylactic solution, more preferably an aqueous prophylactic solution, comprising the quaternary ammonium compound to the one or more articles.

The processes used in the production of quats, for example those described in commonly-owned co-pending applications PCT US2005/010162 and U.S. Ser. No. 60/730,821, typically produce quats in an aqueous solution. The aqueous solution typically comprises water, at least one polar organic co-solvent, and one or more quats, as described herein. Polar organic co-solvents preset in these aqueous solutions typically have some compatibility with water since water is typically a component of the aqueous solution. Polar organic co-solvents are typically selected from several classes of compounds, such as: alcohols, such as methanol, ethanol, isopropyl alcohol, propanol, butanol, isobutyl alcohol, C₁-C₆ alcohols, C₁-C₄ alcohols, and the like with methanol being a preferred example; polyalcohols, such as ethylene glycol, propylene glycol, and the like; esters, such as ethyl acetate, propyl acetate, formates, and the like; ethers, such as methyl tert-butyl ether, dioxane, glymes, and the like; and carbonyl-containing solvents, such as acetone, acetaldehyde, and the like. It should be noted that in some embodiments, only one polar organic co-solvent is used, and in other embodiments, more than one, sometimes two, or in other embodiments more that two, polar organic co-solvents are used.

These aqueous solutions generally have a polar organic co-solvent to water ratio in the range of from about 10:90 up to about 99:1 (wt. co-solvent:wt. water based on the combination of the water and polar organic co-solvent), and the exact amount of the polar organic co-solvent and water is selected according to the selection of R₁, R₂, R₃ and R₄. In general, it is preferred that the ratio of co-solvent:water, by weight and on the same basis, is within the range of from about 50:50 to about 99:1, about 60:40 to about 99:1 is more preferred, about 70:30 to about 98:2 is even more preferred, and about 80:20 to about 95:5 is yet more preferred.

It has generally been found that aqueous solutions having a higher ratio of co-solvent to water are preferred for quats containing very hydrophobic alkyl substituent groups, e.g., double tailed or twin tailed quats where the alkyl groups are C₁₀-C₂₀, for example, while aqueous solutions having a lower ratio of co-solvent to water are preferred for boron-quats having less hydrophobic alkyl substituent groups, e.g., a (C₂-C₆) alkyltrimethylammonium salt.

The aqueous solutions can contain as the polar organic co-solvent an alcohol, and thus, the aqueous solution comprises a mixture of alcohol and water. In this embodiment, it is typically preferred that the aqueous solution comprises a mixture of a C₁-C₆ alcohol and water in a ratio of from 10:90 to 99:1, by weight, on the same basis as above. Even more preferred is an aqueous solution that comprises a mixture of a C₁-C₄ alcohol and water in a ratio of from about 50:50 to about 99:1, about 60:40 to about 99:1 is more preferred, about 70:30 to about 98:2 is even more preferred, and about 80:20 to about 95:5 is yet more preferred, all by weight and on the same basis. A preferred aqueous solution used in the production of quat(s) is a mixture of methanol and water in a ratio of about 85:15, by weight, based on the water and alcohol.

It should be understood that the aqueous solutions can comprise water, at least one polar organic co-solvent and the quat(s). However, when describing the amount of water and polar organic co-solvent in the aqueous solution, these ratios were based on the amount of polar organic co-solvent and water. Thus, when considering the amounts of these components and the quat in the solution, the mixture is a ternary composition comprising at least three major components, water, polar organic co-solvent, and the quat(s) “salt”. Thus, the ratio of the components of the aqueous solution can be represented as a ratio of wt. quat:wt. polar organic co-solvent:wt. water, based on the aqueous solution. By way of example, an aqueous solution formed by adding 25% by weight of a quat salt to a mixture comprising an 85:15 by weight mixture of metanol:water, would have a ternary composition, by weight, of 25:64:11, quat salt:metahol:water by weight, based on the aqueous solution.

Because of economic and/or process considerations these aqueous solutions generally have a concentration of quat(s) ranging from about 1 to about 50 wt. % quat, based on the aqueous solution. If the quat concentration of the aqueous solution is in the range of from about 1 to about 10 wt. %, based on the aqueous solution, then the aqueous solution can be applied to substrates as is, but these aqueous solutions are generally only available with quat concentrations in the range of from about 10 to about 30 wt. %, based on the aqueous solution, of the quat(s), more typically in the range of from about 20 to about 30 wt. %, on the same basis. The inventors hereof have discovered that quat(s) concentrations this high are not necessary for providing the desired characteristics to the one or more articles to which they are applied and ranges much lower are effective and less costly. Thus, in the practice of the present invention, a diluent can be added to the aqueous solution to form a prophylactic solution, obviously comprising the diluent and the same components as the aqueous solution, having a quat concentration in the range of from about 1 to about 10 wt. %, in some embodiments in the range of from about 2 to about 8 wt. %, and in some embodiments in the range of about 4 to about 6 wt. %, all based on the prophylactic solution. Diluents suitable for use herein can be selected from polar organic co-solvents, as described above, water, and mixtures thereof. In some embodiments, the diluent is water.

Alternative Embodiments

In some embodiments, one, in some embodiments more than one, quaternary ammonium compound(s) having the structure can be used:

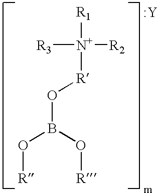

wherein R₁, R₂, R₃, Y, and m are as described above, R′ is a hydrocarbon group having from 1-10 carbon atoms, in some embodiments in the range of from 1 to 5, in some embodiments in the range of from 1 to 3, and R″ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. In some embodiments R″ and R′″ are selected from unsubstituted alkyl groups having in the range of from 1 to 20 carbon atoms, in some embodiments in the range of from 1 to 15, and in other embodiments in the range of from 6 to 14.

In another embodiment, a first and second quaternary ammonium compound are used in the practice of the present invention. The first quaternary ammonium compound can have any of the formulas described above, but in some embodiments the first quaternary ammonium compound be characterized by the formula:

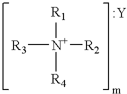

wherein the first quaternary ammonium composition is metal coupler free, m is as described above, and Y is selected from borates, as described above including preferred embodiments. In this embodiment, the four carbon groups, i.e., R₁, R₂, R₃ and R₄, of the first quaternary ammonium compound are selected from those described above, including preferred embodiments.

In this embodiment, the second quaternary ammonium compound can have any of the formulas described above included preferred embodiment, but it is preferred that the second quaternary ammonium compound be characterized by the structure:

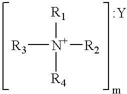

wherein the second quaternary ammonium composition is metal coupler free, m is as described above, and Y is selected from a counter-anion other than borate, in some embodiments carbonates and/or bicarbonates. In this embodiment, the four carbon groups, i.e., R₁, R₂, R₃ and R₄, of the first quaternary ammonium compound are selected from those described above, including preferred embodiments.

It is within the scope of the present invention that when Y of the second quaternary ammonium compound is bicarbonate or carbonate, that a third quaternary ammonium compound having the same general formula as the second quaternary ammonium compound be present. In this embodiment, the third quaternary ammonium compound is metal coupler free, and the four carbon groups, i.e., R₁, R₂, R₃ and R₄, of the third quaternary ammonium compound are selected from those described above. In this embodiment, the Y counter-anion of the third quaternary ammonium compound is bicarbonate or carbonate, but not the same as the second quaternary ammonium compound. For example, if Y of the second quaternary ammonium compound is carbonate, then Y of the third quaternary ammonium compound is bicarbonate, and vice versa.

Application to Article(s)

The at least one quaternary ammonium compound, aqueous solution or prophylactic solution, in some embodiments an aqueous solution in other embodiments a prophylactic solution, can be applied to the one or more articles during any stage of the construction of the building. For instance, they can be applied to the concrete slab when it is complete, to the wall studs as they are put in place, the ceiling joists as they are put in place the sheet-rock as it is hung, the ceiling tiles as they are in put in place, etc. In some embodiments, the prophylactic solution is applied to the articles after the building has been completed. In other embodiments, the prophylactic or aqueous solution is applied to the wall studs, and/or cement, and/or ceiling joists, and/or wood roofing material before they are covered with other materials, i.e. roofing shingles, etc. In this and other embodiments, the prophylactic or aqueous solution can also be applied to other articles such as sheet rock or wall-boards such as paneling, bricks, etc. It is also contemplated that the prophylactic or aqueous solutions containing different quats can be used to achieve desired results.

The method by which the at least one quaternary ammonium compound, aqueous solution or prophylactic solution it is applied to the one or more article(s) is not critical to the present invention. Non-limiting examples of suitable application methods include coating, dipping, soaking, brushing, spraying, and the like. Because of the nature of most applications, in some embodiments the quaternary ammonium compound is applied through spraying, in some embodiments with a pressure spraying device such as a pressure washer or pressurized spraying system, e.g. a garden sprayer pressurized by hand pumping.

The above description is directed to several embodiments of the present invention. Those skilled in the art will recognize that other embodiments, which are equally effective, could be devised for carrying out the spirit of this invention. It should also be noted that preferred embodiments of the present invention contemplate that all ranges discussed herein include ranges from any lower amount to any higher amount.

What is claimed:

1. A method for preventing and/or inhibiting the growth of microbial organisms comprising applying to one or more articles at least one quaternary ammonium compound having the formula: 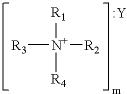
wherein Y is selected from H₂BO₃⁻; HBO₃⁻²; BO₃⁻²; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy, or oxo groups; and m is 1, 2, 3, 4, or 5, depending on the selection of Y; and
wherein said one or more articles are present in an environment that can facilitate or encourage the growth of at least one microbial, and said at least one microbial is selected from one or more molds, mildews, funguses, and the like.

2. The method according to claim 1 wherein said one ore more article(s) is any one of the following: i) gypsum board; ii) ceiling tiles or other ceiling material made form natural or synthetic materials, iii) particleboard or other similar composite material used in the construction of a building; iv) synthetic wood; v) carpeting; vii) padding used under carpeting; viii) insulation, be it made from natural or synthetic materials; ix) wood; x) concrete or other similar porous material; xi) porous tiles such as flooring or wall tiles; xii) synthetic materials used in the construction of buildings; xiii) bricks; xiv) curtains; xv) bed sheets; xvi) furniture; xvii) wall paneling; and xviii) any combinations thereof.

3. The method according to claim 2 wherein said quaternary ammonium compound is applied to said one or more article(s) by applying an aqueous or prophylactic solution containing in the range of from about 1 to about 10 wt. %, based on the aqueous or remediation solution, of said quaternary ammonium compound, wherein said aqueous or prophylactic solution is metal coupler free.

4. The method according to claim 3 wherein said quaternary ammonium compound is applied to said one or more article(s) by a method selected from coating, dipping, soaking, brushing, spraying, and the like

5. The method according to claim 4 wherein R₁ and R₂ are independently chosen from alkyl groups having in the range of from 1 to 3 carbon atoms, and R₃ and R₄ are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

6. The method according to claim 3 wherein R₁ and R₂ are methyl groups and R₃ and R₄ are independently selected from unsubstituted alkyl groups containing from 8 to 16 carbon atoms.

7. The method according to claim 6 wherein the carbon atom containing group of R₃ has a different number of carbons than the carbon atom containing group of R₄.

8. The method according to claim 1 wherein one of R₃ or R₄ is an unsubstituted alkyl group containing in the range of from 8 to 10 carbon atoms, and one of R₃ or R₄ is an unsubstituted alkyl group containing in the range of from 12 to 16 carbon atoms.

9. The method according to claim 5 wherein one of R₃ or R₄ is an unsubstituted alkyl group containing from 8 to 10 carbon atoms, and one of R₃ or R₄ is an unsubstituted alkyl group containing in the range of from 12 to 14 carbon atoms.

10. The method according to claim 1 wherein Y is BO₃⁻³, and m is 3.

11. The method according to claim 1 wherein at least one of R₁, R₂, R₃ and R₄ is a shared radical.

12. The method according to claim 11 wherein:
a) i) m is 2, and ii) Y is selected from HBO₃⁻²; B₄O₇⁻²; and B₅O₈⁻²; or
b) i) m is 3, ii) said quaternary ammonium compound contains 2 shared anions Y, and iii) one of the shared anions is selected from H₂BO₃⁻; HB₄O₇⁻; B₃O₅⁻; and BO₂⁻ and the other shared anion is selected from HBO₃⁻²; B₄O₇⁻²; and B₅O₈⁻²; or
c) i) m is 3, and ii) said quaternary ammonium compound contains 3 shared anions Y, each Y independently selected from H₂BO₃⁻; HB₄O₇⁻; B₃O₅⁻; and BO₂⁻.

13. The method according to claim 5 wherein said at least one quaternary ammonium compound has the formula: 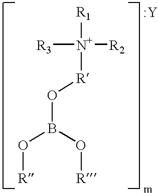
wherein Y is selected from H₂BO₃⁻; HBO₃⁻²; BO₃⁻³; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂]ₙR₅; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y; R′ is a hydrocarbon group having from 1 -10 carbon atoms; and R″ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

14. The method according to claim 5 wherein a first, second, and optionally a third, quaternary ammonium compound are applied to said one or more article(s) wherein
a) said first quaternary ammonium compound is characterized by the formula: 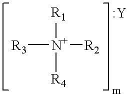
wherein Y is selected from H₂BO₃⁻; HBO₃⁻²; BO₃⁻³; B₄O₇⁻²; HB₄O₇⁻; B₃O₅⁻; B₅O₈⁻²; and BO₂⁻; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y; and
b) said second quaternary ammonium compound is characterized by the formula: 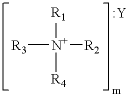
wherein s Y is selected from PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y.

15. The method according to claim 14 wherein each R₁ and R₂ of said first and second quaternary ammonium compound is independently chosen from alkyl groups having in the range of from 1 to 3 carbon atoms, and each R₃ and R₄ of said first and second quaternary ammonium compounds are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

16. The method according to claim 15 wherein R₃ of said first quaternary ammonium compound has a different number of carbons than R₄ of said first quaternary ammonium compound, and/or R₃ of said second quaternary ammonium compound has a different number of carbons than R₄ of said second quaternary ammonium compound.

17. The method according to any of claims 1, 11, 13, or 14 said one or more article(s) is a cellulosic article and the application of said at least one quaternary ammonium compound imparts to said one or more article(s) termite repellant and/or flame retardant properties.

18. The method according to any of claims 1, 11, 13, or 14 wherein said one or more article(s) is used for or in the construction of a building and said at least one quaternary ammonium compound is applied to said one or more article(s) at any stage during the construction of said building.

19. The method according to claim 18 wherein said one or more article is a part of or present in an existing building.

20. The method according to claim 14, wherein said optional third quaternary ammonium compound is applied to said one or more article along with said first and second quaternary ammonium compound; the counter anion Y of said second quaternary ammonium compound is CO₃⁻²; and the third quaternary ammonium compound is characterized by the formula: 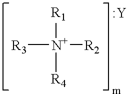
wherein Y is selected from HCO₃⁻; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1.

21. The method according to claim 20 wherein R₃ of said third quaternary ammonium compound has a different number of carbons than R₄ of said third quaternary ammonium compound.

22. The method according to claim 20 wherein said one or more article(s) is a cellulosic article and the application of said at least one quaternary ammonium compound imparts to said one or more article termite repellant and/or flame retardant properties.

23. The method according to claim 20 wherein said at least one quaternary ammonium compound is applied to said one or more article(s) at any stage during the construction of said building.

24. A method comprising preventing and/or inhibiting the growth of microbial organism by applying to one or more article at least one quaternary ammonium compound having the formula: 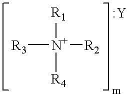
wherein:
a) Y is selected from H₂BO₃⁻; HBO₃⁻²; BO₃⁻³; B₄O₇⁻²; HB₄O₇⁻; B₃O₅⁻; B₅O₈⁻²; BO₂⁻; and combinations thereof; R₁ and R₂ are independently chosen from alkyl groups having in the range of from 1 to 3 carbon atoms; R₃ and R₄ are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3, depending on the selection of Y;
b) said one or more article(s) comprises at least one microbial selected from one or more molds, mildews, funguses, and the like;
c) said one or more quaternary ammonium compound is applied to said one or more article(s) by applying an aqueous or prophylactic solution containing in the range of from about 1 to about 10 wt. %, based on the aqueous or remediation solution, of said quaternary ammonium compound, wherein said aqueous or prophylactic solution is metal coupler free and said aqueous or prophylactic solution is applied to said one or more article(s) by a method selected from coating, dipping, soaking, brushing, spraying, and the like; and
d) said one or more article(s) is any one of the following: i) gypsum board; ii) ceiling tiles or other ceiling material made form natural or synthetic materials; iii) particleboard or other similar composite material used in the construction of a building; iv) synthetic wood; v) carpeting; vii) padding used under carpeting; viii) insulation, be it made from natural or synthetic materials; ix) wood; x) concrete or other similar porous material; xi) porous tiles such as flooring or wall tiles; xii) synthetic materials used in the construction of buildings; xiii) bricks; xiv) curtains; xv) bed sheets; xvi) furniture; xvii) wall paneling; and xviii) any combinations thereof.

25. The method according to claim 24 wherein the carbon atom containing group of R₃ has a different number of carbons than the carbon atom containing group of R₄.

26. The method according to claim 24 wherein R₁ and R₂ are methyl groups and R₃ and R₄ are independently selected from unsubstituted alkyl groups containing from 8 to 16 carbon atoms.

27. The method according to claim 24 wherein one of R₃ or R₄ is an unsubstituted alkyl group containing in the range of from 8 to 10 carbon atoms, and one of R₃ or R₄ is an unsubstituted alkyl group containing in the range of from 12 to 16 carbon atoms.

28. The method according to claim 24 wherein one of R₃ or R₄ is an unsubstituted alkyl group containing from 8 to 10 carbon atoms, and one of R₃ or R₄ is an unsubstituted alkyl group containing in the range of from 12 to 14 carbon atoms.

29. The method according to claim 24 wherein at least one of R₁, R₂, R₃, and R₄ is a shared radical.

30. The method according to claim 29 wherein:
a) i) m is 2, and ii) Y is selected from HBO₃⁻²; B₄O₇⁻²; and B₅O₈⁻²; or
b) i) m is 3, ii) said quaternary ammonium compound contains 2 shared anions Y, and iii) one of the shared anions is selected from H₂BO₃⁻; HB₄O₇⁻; B₃O₅⁻; and BO₂⁻ and the other shared anion is selected from HBO₃⁻²; B₄O₇⁻²; and B₅O₈⁻²; or
c) i) m is 3, and ii) said quaternary ammonium compound contains 3 shared anions Y, each Y independently selected from H₂BO₃⁻; HB₄O₇⁻; B₃O₅⁻; and BO₂⁻; or
d) i) m is 3, and ii) Y is BO₃⁻³.

31. The method according to claim 24 wherein a first, second, and optionally a third quaternary ammonium compound are applied to said one or more article(s)
wherein
a) said first quaternary ammonium compound is characterized by the formula: 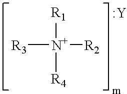
wherein Y is selected from H₂BO₃⁻; HBO₃⁻²; BO₃⁻³; B₄O₇⁻²; HB₄O₇⁻; B₃O₅⁻; B₅O₈⁻²; and BO₂⁻; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y; and
b) said second quaternary ammonium compound is characterized by the formula: 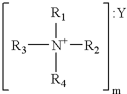
wherein Y is selected from PO₄⁻³, HPO₄⁻²; H₂PO₄⁻; P₂O₇⁻⁴, P₃O₁₀⁻⁵, PO₃⁻; CO₃⁻²; HCO₃⁻; [CO₂⁻]ₙR₅; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y.

32. The method according to claim 31 wherein each R₁ and R₂ of said first and second quaternary ammonium compound is independently chosen from alkyl groups having in the range of from 1 to 3 carbon atoms, and each R₃ and R₄ of said first and second quaternary ammonium compounds are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

33. The method according to claim 31 wherein R₃ of said first quaternary ammonium compound has a different number of carbons than R₄ of said first quaternary ammonium compound and/or R₃ of said second quaternary ammonium compound has a different number of carbons than R₄ of said second quaternary ammonium compound.

34. The method according to any of claims 24 or 31 wherein said one or more article(s) is a cellulosic article and the application of said at least one quaternary ammonium compound imparts to said one or more article(s) termite repellant and/or flame retardant properties.

35. The method according to any of claims 24, or 31 wherein said one or more article is used for or in the construction of a building and said at least one quaternary ammonium compound is applied to said one or more article at any stage during the construction of said building.

36. The method according to claim 35 wherein said at least one quaternary ammonium compound is applied to one or more article(s) that is a part of, or present in, an existing building.

37. The method according to claim 31, wherein said optional third quaternary ammonium compound is applied to said one or more article(s) along with said first and second quaternary ammonium compound; the counter anion Y of said second quaternary ammonium compound is CO₃⁻²; and the third quaternary ammonium compound is characterized by the formula: 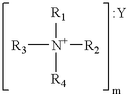
wherein Y is selected from HCO₃⁻; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1.

38. The method according to claim 37 wherein R₃ of said third quaternary ammonium compound has a different number of carbons that R₄ of said third quaternary ammonium compound.
